(19) United States
(12) Patent Application Publication
(10) Pub. No.: US 2006/0066775 A1
(43) Pub. Date: Mar. 30, 2006

(54) Liquid crystal display projector, liquid crystal display panel, and manufacturing method thereof

(76) Inventor: Kimiaki Toshikiyo, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/235,225

(22) Filed: Sep. 27, 2005

(30) Foreign Application Priority Data
Sep. 29, 2004 (JP) 2004-285316

(51) Int. Cl. G02F 1/1335

(52) U.S. Cl. 349/95

(57) ABSTRACT

An optical device and the like which can collect incident light with a higher angle than an existing microlens is provided in order to realize a liquid crystal display panel corresponding to an optical system having a greater incident angle θ.

A unit pixel (20 μm square in size) of a liquid crystal display panel includes a gradient index lens 1, a color filter 2 for green G, a black matrix filter 3, transparent electrodes 4, a liquid crystal layer 5, a counter glass substrate 6, and a glass substrate 7.

The gradient index lens having a concentric circle structure is made up of high refractive index materials 10 (e.g. TiO₂ (n=2.43)) and low refractive index materials 11 (e.g. air (n=1.0)), and a difference of radiuses of parameters of circular light-transmitting films that are adjacent to each other is 200 nm. Further, the film thickness is 0.5 μm.

### BACKGROUND OF THE INVENTION

(1) Field of the Invention

The present invention relates to a liquid crystal display (LCD) projector, an LCD panel used for an LCD projection television and the like, and a manufacturing method thereof.

(2) Description of the Related Art

In recent years, a technology of manufacturing a projection display apparatus (LCD projector) using an active matrix LCD panel has been rapidly developed. It results from a rapid growth of a market of a rear-projection television and home theater related products using an LCD projector as a key device.

In particular, the rear-projection television has been a focus of attention as a large-screen television which is an alternative to a plasma television and an LCD television. FIG. 1 is a diagram showing a structure of a rear-projection television 85. An image projected from an LCD projector 82 is projected onto a screen 84 through a reflecting mirror 83. A viewer enjoys watching the image projected on a rear-side of the screen 84.

Currently, there are three challenges for the large-screen television. They are the realization of lower price, the achievement of high picture quality, and the improvement of a design. Here, the rear-projection television has already gained predominance in price over the plasma television and the LCD television. Therefore, as a present technical challenge, it is focused to realize high picture quality and improve its design.

The challenge to realize high picture quality is how to obtain a high-definition of an LCD panel that is how to obtain a finer pixel. Also, it is significant to make the LCD panel thinner for a good design so that the challenge is how to make an optical system compact in size. In future, it is necessary to make a pixel size of the LCD panel smaller without deteriorating the luminance of the LCD panel so as to obtain a system with a short focal point, for realizing a large television with-a large screen, high picture quality and a low price.

Since a luminance of the LCD projector significantly depends on a transmittance of illumination-light that is incident onto an LCD panel, it is an important factor for improving the luminance to ensure leading the incident light to an aperture of a pixel.

FIG. 5 is a diagram showing a fundamental structure of a unit pixel which is a constituent of a conventional single-panel LCD panel for a general use. The unit pixel shown in FIG. 5 has a glass substrate 7 on which transparent electrodes 4 corresponding to each color light (red, green or blue) are formed, and a liquid crystal layer 5 and a color filter 2 are sequentially placed on the above. The color filter 2 is embedded in a black matrix filter 3 and a counter substrate 6 that is made of glass is formed on the black matrix filter 3.

Here, the black matrix filter 3 is placed in order to prevent light from passing except through the transparent electrodes 4 of each unit pixel. In the black matrix filter 3, only the portions of the transparent electrodes 4 are apertures and other areas are colored in black so as not to transmit light. As shown in FIG. 5, light 95 (light indicated with dashed lines) which is incident vertical to the aperture is separated into colors through one of red (R), green (G), and blue (B) color filters 2 that is formed in the aperture of the black matrix filter 3, reaches the liquid crystal layer 5, and is transmitted and outputted to the glass substrate 7 side depending on a state of the transparent electrodes 4. Further, the light 96 (light indicated with solid lines) which is incident onto other than the aperture of the black matrix filter 3 is blocked by the light-shielding unit so that it cannot pass through the liquid crystal layer 5.

Thus, by placing the black matrix filter, light is transmitted only through the pixel portion formed on the LCD panel and the contrast of the displayed image becomes clear so that a projected image by the LCD projector has high picture quality.

However, the black matrix filter placed on the LCD panel limits light which passes through the LCD panel, causing a problem of lowering an illumination of light projected onto a screen. Since an aperture ratio of the black matrix filter is around 25 to 45 percent, it can be said that half amount or more of light that is incident from a side of a light source is blocked with the black matrix filter.

In order to solve the problem, a method of forming a microlens 90 on the top of each unit pixel 9 is adapted (FIG. 4). The light 89 (light indicated with dashed lines) collected by the microlens 90 passes through the color filter 2 and the liquid crystal layer 5 via the aperture of the black matrix filter 3. As the result of this light-collecting effect, a ratio of light blocked with the black matrix filter 3 is reduced so that a utilization ratio of the illumination-light is increased as well as the luminance of the LCD projector. Thus, a microlens is used in most of LCD panels due to its relatively high light-collection efficiency.

As described in the above, in an LCD projector using a microlens, it is suggested an example of a structure in which an optical device having a periodical structure is placed in each unit pixel (e.g. refer to [patent reference 1] Japanese Patent Publication No. 11-202793). This patent reference 1 discloses an embodiment of an LCD projector including an optical device which has a color separation function and a light-collecting function at the same time.

In addition, as an LCD panel using a micro light-collecting panel, it is suggested an example of a structure in which a reflecting mirror in a micron in size and a refractive index profile structure are placed in each unit pixel (e.g. refer to [patent reference 2] Japanese Patent Publication No. 6-118208). This patent reference 2 discloses an embodiment which describes to increase light-collection efficiency by surrounding a periphery of the aperture with a tapered reflecting mirror or a material having a different refractive index.

In future, it is necessary to develop an LCD panel which corresponds to light which is incident with a wide angle, for realizing an LCD panel of a short focal point system. Therefore, the light which is incident at a specific angle needs to be ensured to be led to the aperture.

However, in the case of using the microlens, the light-collection efficiency decreases depending on the incident angle of the signal light. In other words, as shown in FIG. 4, the light-collection efficiency of light 8 (light indicated with solid lines) which is incident diagonally to the lens is decreased, while the light 89 which is incident vertical to the lens can be collected highly efficiently. This is because that the diagonally incident light 8 is blocked with the black matrix filter 3 in the pixel so that the light 8 does not reach until the liquid crystal layer 5.

The liquid crystal panel is made up of unit pixels that are arranged in a two-dimensional array. Therefore, in the case of light which is incident with a wide angle, an incident angle at a central unit pixel is different from an incident angle at a peripheral unit pixel (refer to FIG. 2). As the result, there is a problem that the light-collection efficiency of the peripheral unit pixel is lower than that of the central unit pixel.

FIG. 3 is a diagram showing a dependency on the incident angle of the light-collection efficiency at an aperture of a black matrix filter in an LCD panel using a conventional microlens. As shown in FIG.3, the incident light with an incident angle until around 20° can be collected highly efficiently. However, the light-collection efficiency rapidly decreases as the incident angle exceeds 20°. As a result, an amount of light collected at the peripheral unit pixels is about 40 percent of that at the central unit pixels so that unevenness of luminance occurs in the projected image. In addition, this ratio further decreases as the pixel size decreases. Therefore, it becomes a large obstacle for realizing a miniaturization of an LCD projector and a thinner rear-projection television.

### SUMMARY OF THE INVENTION

Considering the aforementioned problems, an object of the 10 present invention is to provide an optical device and the like which can collect light that is incident at a higher angle than by an existing microlens in order to realize a liquid crystal display panel corresponding to an optical system with a greater incident angle θ.

In order to solve the aforementioned problems, a liquid crystal display according to the present invention is a liquid crystal display panel including light-transmittable unit pixels that are arranged in a two-dimensional array, wherein each of the unit pixels includes: an optical device having a light-transmitting film which collects incident light; and a liquid crystal layer which allows the light that has passed through the optical device to pass through an aperture of a light-shielding layer, and wherein in the optical device, a refractive index distribution for incident light from a fixed direction is asymmetrical to a surface-center of the light-transmitting film. Accordingly, a development of a liquid crystal display panel corresponding to incidence with a wide angle can be allowed so that a liquid crystal display projector for high picture quality and high luminance can be realized.

Further, in the optical device, the asymmetrical refractive index distribution is also formed in a region adjacent to an optical device of another unit pixel that is adjacent to the current unit pixel.

Accordingly, a light-incident plane becomes a whole pixel region and the light-collecting loss can be reduced.

Further, the liquid crystal display panel includes at least: a first unit pixel for a first color light having a first representative wavelength of the incident light; and a second unit pixel for a second color light having a second representative wavelength of the incident light, the second representative wavelength being different from the first representative wavelength, wherein the first unit pixel includes a first optical device, and the second unit pixel includes a second optical device in which a focal length for the second color light is equal to a focal length for the first color light in the first optical device of the first unit pixel. Accordingly, a lens structure of each pixel unit can be optimized depending on a wavelength of the incident light.

Further, the focal length is set at a predetermined position by controlling the refractive index distribution on the light-transmitting film. Consequently, a focal length of the incident light becomes changeable and a lens can be designed applicable to a specification of each unit pixel.

Further, the refractive index distribution on the light-transmitting film of the optical device is set so that, for light with the greatest light intensity, a light collection efficiency at the aperture is equal to or greater than a predetermined value. Accordingly, a lens structure of each unit pixel can be optimized depending on an incident angle of the incident light and lowering of the light-collection efficiency along with an increase of the incident angle can be prevented.

Further, it is desired that the refractive index distribution on the light-transmitting film of the optical device is defined so that a predetermined value is obtained for a light-collection efficiency at the aperture regardless of a position of a unit pixel in the liquid display crystal panel. Consequently, luminance of each pixel becomes constant so that unevenness of the luminance on the liquid crystal display panel is prevented.

Further, in each of said unit pixels, a position of a focal point of the light collected by the optical device matches a position of the aperture. Accordingly, the aperture can be used most efficiently and the light-collection efficiency becomes high.

Further, the optical device is formed in an in-layer region above the aperture. Accordingly, a position of the light-collecting device can be freely designed.

Further, each of the unit pixels further includes a light-collecting lens on a light-incoming side or a light-outgoing side of the optical device. Consequently, the light-collecting loss in a pixel is reduced so that the optical device is easily designed. Specifically, the light-collecting lens is one of a gradient index lens and a thickness distribution lens.

Further, on the liquid-crystal display panel, a refractive index distribution on the light-transmitting film according to an optical device of a unit pixel positioned in a center of the liquid crystal display panel is different from a refractive index distribution on the light-transmitting film according to an optical device of a unit pixel positioned in a periphery of the liquid crystal panel. Accordingly, the lens structure can be optimized depending on a position of a pixel on the liquid crystal display panel so that unevenness of luminance on the liquid crystal display panel is moderated.

Further, in each of the optical devices,
Δn(x)=Δnₘₐₓ[(Ax²+Bx sin θ)/2π+C]
is approximately satisfied when a difference from a refractive index of a medium on a light-incoming side which depends on a distance x in an in-plane direction is Δn(x), where A is an incident angle of the incident light, Δnₘₐₓ is a maximum value of the difference from the refractive index of the medium on the light-incoming side, and A, B and C are predetermined constants. Accordingly, the light that is incident at a specific angle can be collected at an arbitral position and a gradient index lens which can achieve high light-collection efficiency can be manufactured. Therefore, the luminance of the liquid crystal display panel can be improved.

Also, in each of the optical devices, further, it is desired to approximately satisfy ΔnₘₐₓL=λ, where L is a thickness of the light-transmitting film and λ is a wavelength of the incident light. Accordingly, the maximum phase modulation by the gradient index lens becomes a modulation for a one phase of the incident light and the light-collecting loss becomes a minimum. Therefore, the light can be collected highly efficiently.

Further, the light-transmitting film forms concentric circles that are respective zones obtained by dividing the light-transmitting film by a periodic width in an in-plane direction, the periodic width being equal to or shorter than a wavelength of the incident light, and each zone has a different ratio of a sum of line widths to the periodic width. Accordingly, a gradient index device can be easily manufactured by changing an effective refractive index by changing a line width of a concentric circle.

Herein, it is desired that a shape of a cross-section of said light-transmitting film in a direction of a normal line is a rectangular. Consequently, the sharper refractive index change is generated and light-collectivity is improved.

Also, it is desired that a perimeter of each of the concentric circles is formed to have a step-like shape. Accordingly, a fine processing becomes easier and the manufacturing costs can be reduced.

Further, it is desired that in said light-transmitting film, a light-transmitting material is scattered unevenly, the light-transmitting material having a diameter that is equal to or shorter than a wavelength of light to be incident in an in-plane direction. Using this method, the gradient index device can be easily manufactured by changing an effective refractive index by changing a space between adjacent light transmitting materials.

Further, in the light-transmitting film, it is desired that the refractive index distribution changes continuously. Consequently, a phase of the incident light is continuously changed so that the light-collection efficiency is improved.

Further, the light-transmitting film is made of a high-refractive index transparent material having a refractive index between 1.45 and 3.4.

Furthermore, the light-transmitting film includes one of TiO₂, ZrO₂, Nb₂O₅, Ta₂O₅, Al₂O₃, HfO₂, Si₃N₄ and Si₂N₃. These are high-refractive index materials. Therefore, the thickness of the light-transmitting film can be thinned and the manufacturing process becomes easier.

Also, the light-transmitting film includes one of SiO₂ doped with one of B and P, that is Boro-Phospho Silicated Glass, and Teraethoxy Silane. These are materials generally used in a conventional semiconductor process. Therefore, an optical device can be easily manufactured and the manufacturing costs can be reduced.

Further, each of the unit pixels which is positioned in a center of the liquid display panel is formed so that a central axis of the aperture matches a central axis of the optical device, and each of the unit pixels which is positioned in a periphery of the liquid display panel is formed so that a central axis of the optical device is shifted to the center of the liquid display panel than a central axis of the aperture. Consequently, a low-level shrink structure can be formed and light-transmittance in the peripheral pixels can be further increased so that unevenness of the luminance on the liquid crystal display panel is moderated.

Further, in order to solve the problems, a liquid crystal display projector according to the present invention is a liquid crystal display projector which displays an image on a predetermined screen by applying illumination-light to a liquid crystal panel and projecting the light onto said screen using a projection lens, the light passing through the image displayed on the liquid crystal panel, wherein the liquid crystal display panel includes light-transmittable unit pixels that are arranged in a two-dimensional array, each of the unit pixels includes: an optical device having a light-transmitting film which collects incident light; and a liquid crystal layer which allows the light that has passed through the optical device to pass through an aperture of a light-shielding layer, and wherein in the optical device, a refractive index distribution for incident light from a fixed direction is asymmetrical to a surface-center of the light-transmitting film, and a color filter is placed near the optical device while irradiating the illumination-light to the liquid crystal display panel. Using this method, the usability of the illumination-light can be increased so that a low luminance problem of a single plate liquid crystal display projector can be resolved.

Here, it is desired that the color filter is a dielectric multi-layer film filter. Accordingly, good color reproducibility can be realized even in a fine pixel size. Further, since the filter is formed by an inorganic material so that not only the conventional semiconductor process is adhered to, but also a filter with a small change in an elapsed time can be formed.

Further, a liquid crystal display projector according to the present invention is a liquid crystal display projector which displays an image on a predetermined screen, after allowing a color separation unit to separate illumination-light into colors, by applying the light onto a liquid crystal display panel, synthesizing the light passing through the image displayed on the liquid crystal panel, and projecting the image onto said screen using a projection lens, wherein the liquid crystal display panel includes light-transmittable unit pixels that are arranged in a two-dimensional array, each of the unit pixels includes: an optical device having a light-transmitting film which collects incident light; and a liquid crystal layer which allows the light that has passed through the optical device to pass through an aperture of a light-shielding layer, and wherein in the optical device, a refractive index distribution for incident light from a fixed direction is asymmetrical to a surface-center of the light-transmitting film. Accordingly, by equipping the optical device optimized according to a color of illumination-light and an incident angle on a liquid crystal display panel, a complicated optical device arrangement of a three-plate liquid crystal display projector can be simplified.

Further, it is desired that the color separation unit separates the light into colors using a dichroic mirror. Consequently, following the conventional technology, a high luminance three-plate liquid crystal projector can be easily manufactured.

Further, it is desired that the color separation unit separates the light into colors using a photonic crystal having a color separation function. Consequently, the color separation optical system can be further miniaturized so that a smaller liquid crystal display projector can be manufactured.

Further, it is desired that the colors of the light separated by the color separation unit are red, green and blue. Consequently, a liquid crystal display panel having the optical devices optimized for respective wavelengths can be manufactured. Therefore, a high luminance liquid crystal display projector can be manufactured.

Additionally, in order to solve the aforementioned problems, a rear-projection television according to the present invention is a rear-projection television which enlarges and projects an image projected from a liquid crystal display projector onto a rear side of a screen using a reflection mirror, wherein the liquid crystal display projector displays an image on a predetermined screen by applying illumination-light to a liquid crystal panel and projecting the light onto said screen using a projection lens, the light passing through the image displayed on the liquid crystal panel, the liquid crystal display panel comprises light-transmittable unit pixels that are arranged in a two-dimensional array, each of the unit pixels includes: an optical device having a light-transmitting film which collects incident light; and a liquid crystal layer which allows the light that has passed through the optical device to pass through an aperture of a light-shielding layer, and wherein in the optical device, a refractive index distribution for incident light from a fixed direction is asymmetrical to a surface-center of the light-transmitting film, and a color filter is placed near the optical device while irradiating the illumination-light to the liquid crystal display panel. Accordingly, a distance of a projection optical system becomes shorter and a thinner rear-projection television can be manufactured.

Further, in order to solve the aforementioned problems, a manufacturing method of a liquid crystal panel according to the present invention is a manufacturing method of a liquid crystal display panel in which light-transmittable unit pixels are arranged in a two-dimensional array, the method including forming a light-transmitting film by nanoimprinting using a mold with a minimum processing measure of 1 nm or less, wherein in the light-transmitting film placed on each of the unit pixels of the liquid crystal display panel, a refractive index distribution for incident light from a fixed direction is asymmetrical to a face-center of the light-transmitting film, the light-transmitting film being formed by a semiconductor process. Consequently, a fine concentric structure can be manufactured easily for large amount. In addition, a displacement of a correspondence position between pixels is prevented and a process of adjustment is reduced. Therefore, a low priced optical device can be realized.

Further, a manufacturing method of a liquid crystal display panel according to the present invention is a manufacturing method of a liquid crystal display panel in which light-transmittable unit pixels are arranged in a two-dimensional array, the method including forming a light-transmitting film by one of ion implantation and ion exchange, wherein in the light-transmitting film placed on each of the unit pixels of the liquid crystal display panel, a refractive index distribution for incident light from a fixed direction is asymmetrical to a face-center of the light-transmitting film, the light-transmitting film being formed by a semiconductor process. Consequently, a phase change of the incident light becomes continuous so that an optical device which can achieve high-light-collection efficiency can be manufactured.

Furthermore, a manufacturing method of a liquid crystal display panel according to the present invention is a manufacturing method of a liquid crystal display panel in which light-transmittable unit pixels are arranged in a two-dimensional array, the method comprising forming a light-transmitting film using one of an electron beam rendering and a light-beam rendering, wherein in the light-transmitting film placed on each of the unit pixels of the liquid crystal display panel, a refractive index distribution for incident light from a fixed direction is asymmetrical to a face-center of the light-transmitting film, the light-transmitting film being formed by a semiconductor process. Consequently, the conventional semiconductor process can be used and the manufacturing costs can be reduced.

The liquid crystal display panel of the present invention includes the aforementioned optical device so that miniaturization and high resolution of the liquid crystal display panel, an improvement of luminance, and a simplification of the manufacturing process can be realized.

Further information about technical background to this application, the disclosure of Japanese Patent Application No. 2004-285316 filed on Sep. 29, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a diagram showing a structure of a rear-projection television according to a conventional technology;

FIG. 2 is a diagram showing a fundamental structure of a pixel arrangement of an LCD panel according to the conventional technology;

FIG. 3 is a diagram showing a light-collecting characteristic of the LCD panel using a microlens according to the conventional technology;

FIG. 4 is a diagram showing a fundamental structure of the LCD panel pixel using the microlens according to the conventional technology;

FIG. 5 is a diagram showing a fundamental structure of the LCD panel pixel according to the conventional technology;

FIG. 6 is a diagram showing a fundamental structure of one pixel according to a first embodiment of the present invention;

FIG. 7 is a diagram showing an example of a structure of a top surface of a gradient index lens according to the first embodiment of the present invention;

FIG. 8 is a diagram showing an example of a structure of a cross-section of the gradient index lens according to the first embodiment of the present invention;

FIG. 9 is a diagram showing a refractive index distribution of the gradient index lens according to the first embodiment of the present invention;

FIG. 10 is a diagram showing a phase modulation of light according to the first embodiment of the present invention;

FIGS. 11A to 11C are scanning electron microscope photographs of the gradient index lens having a concentric circle structure according to the first embodiment of the present invention;

FIG. 12A to 12D are diagrams, each of which shows a comparison between a round incident window region and a square incident window region according to the first embodiment of the present invention;

FIGS. 13A to 13D are diagrams showing a process of manufacturing a gradient index lens according to the first and second embodiments of the present invention;

FIG. 14 is a diagram showing a fundamental structure of a pixel arrangement of an LCD panel according to the second embodiment of the present invention;

FIGS. 15A to 15C are diagrams, each of which shows a structure of a cross-section of a pixel according to the second embodiment of the present invention;

FIGS. 16A to 16C are diagrams, each of which shows a refractive index distribution of the gradient index lens according to the second embodiment of the present invention;

FIG. 17 is a diagram showing a position of a light-collecting spot according to the second embodiment of the present invention;

FIG. 18 is a diagram showing light-collection efficiency of a lens according to the second embodiment of the present invention;

FIG. 19 is a diagram showing a fundamental structure of one pixel according to a third embodiment of the present invention;

FIG. 20 is a diagram showing a structure of a top surface of a gradient index lens according to the third embodiment of the present invention;

FIGS. 21A to 21E are diagrams showing a process of manufacturing the gradient index lens according to the third embodiment of the present invention;

FIG. 22 is a diagram showing a fundamental structure of one pixel according to a fourth embodiment of the present invention;

FIG. 23 is a diagram showing an example of a structure of a top surface of a gradient index lens according to the fourth embodiment of the present invention;

FIG. 24 is a diagram showing another example of a structure of a top surface of the gradient index lens according to the fourth embodiment of the present invention;

FIGS. 25A to 25E are diagrams showing a process of manufacturing a gradient index lens according to the fourth embodiment of the present invention;

FIG. 26 is a diagram showing a fundamental structure of one pixel according to a fifth embodiment of the present invention;

FIG. 27A is a diagram showing a structure of a top surface f the gradient index lens according to the fifth embodiment of the present invention, and FIG. 27B is a diagram showing a refractive index distribution of said gradient index lens;

FIG. 28 is a diagram showing a structure of a cross-section of an LCD panel according to a sixth embodiment of the present invention;

FIG. 29 is a diagram showing a structure of a single-plate LCD projector according to a seventh embodiment of the present invention;

FIG. 30 is a diagram showing a structure of a three-plate LCD projector according to an eighth embodiment of the present invention; and

FIG. 31 is a diagram showing a structure of a three-plate LCD projector according to a ninth embodiment of the present invention.

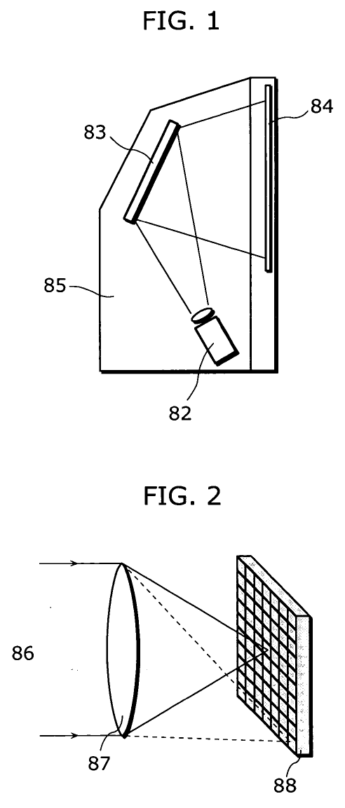

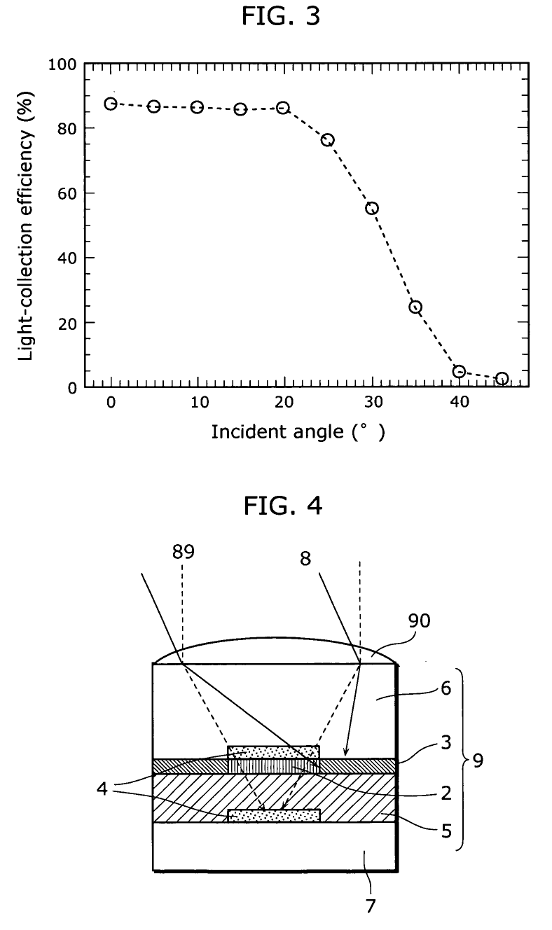

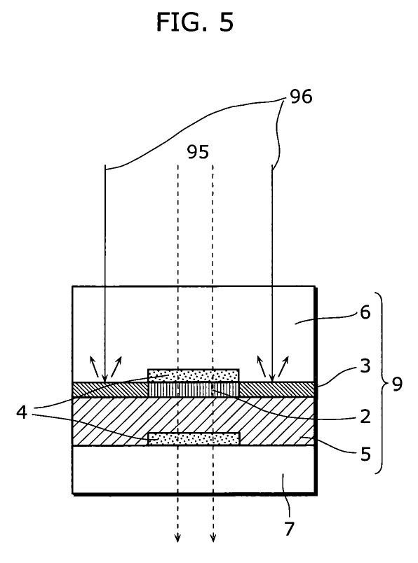

### DESCRIPTION OF THE PREFERRED EMBODIMENTS

Hereafter, embodiments according to the present invention are described in detail with references to drawings.

### First Embodiment

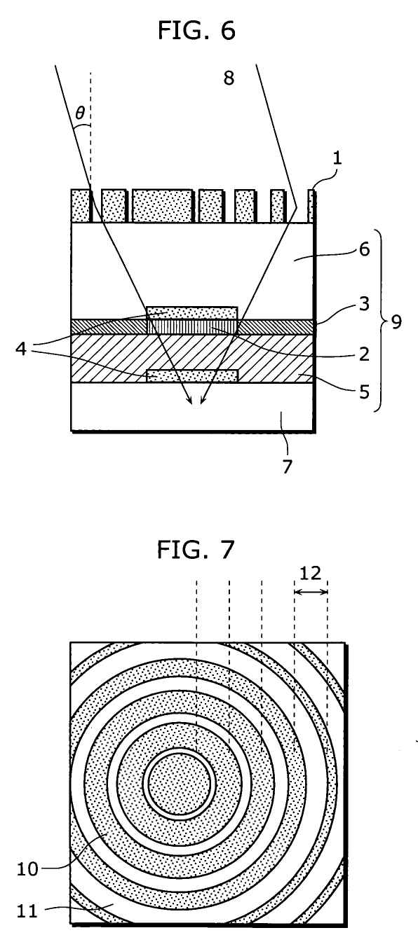

FIG. 6 is a diagram showing a fundamental structure of a unit pixel in an LCD panel according to the present embodiment. Each unit pixel (20 μm square in size) is made up of a gradient index lens 1, a color filter 2 for green (G), a black matrix filter 3, transparent electrodes 4, a liquid crystal layer 5, a counter glass substrate 6, and a glass substrate 7.

FIG. 7 is an example of a top view of the gradient index lens 1. As shown in FIG. 7, the gradient index lens 1 is made up of high refractive index materials 10 (e.g. TiO₂ (n=2.43)) and low refractive index materials 11 (e.g. air (n=1.0)). Here, each material forms a concentric circle as well as a cylinder. A space 12 between adjacent cylinders (i.e. a difference of average radiuses between the cylinders) is 20 nm. Also, the film thickness of the gradient index lens 1 is 0.4 μm.

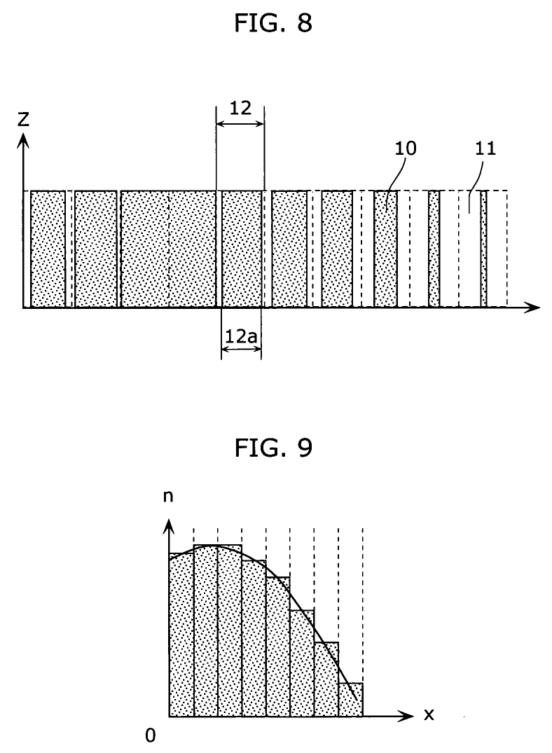

FIG. 8 is a diagram showing an example of a structure of a cross-section of the gradient index lens 1. As shown in FIG. 8, a line width 12a of a concentric cylinder is the widest at a center part of a circle and the line width 12a becomes gradually narrower in a direction toward an outer cylinder. Herein, in the case where a space 12 between cylinders (also referred to as a periodic width) is equal to or smaller than a wavelength of the incident light, an effective refractive index can be calculated by a volume ratio between a high refractive index material and a low refractive index material. The best characteristic feature of the present invention is that the refractive index distribution can be freely controlled by only changing the line width (refer to Japanese Patent Applications No. 2003-421111 and No. 2004-117689).

The variation of the refractive indexes of the gradient index lens according to the present embodiment is shown as in FIG. 9 and is asymmetrical. The refractive index of the gradient index lens is the highest in the center part of the circle and is decreased gradually in a direction toward an edge. In other words, the refractive index distribution for light which is incident from a predetermined diagonal direction as the incident light 8 shown in FIG. 6 is asymmetrical to the center (also referred to as a face-center) of the gradient index lens.

A parabola indicated with a solid line in FIG. 9 shows a refractive index distribution Δn(x) for collecting incident light with a wavelength λ (550 nm) in a focal length f (in the present embodiment, a distance from a lower portion of a lens to a transparent electrode). The refractive index distribution Δn(x) is described in the following equation (1).
Δn(x)=Δnₘₐₓ└(Ax²+Bx sin θ)/2π+C┘(A, B and C are constant) (1)

Here, Δnₘₐₓ is a refractive index difference (here, the value is 1.43) between a light-incoming side medium and a lens material. Further, the equation (1) can set parameters as follows:
A=−(k₀n₁)/2f (1-1)
B=−k₀n₀ (1-2)
k₀=2π/λ (1-3)
where n₀ is a refractive index of the light-incoming side medium, and n₁ is a refractive index of the light-outgoing side medium. Accordingly, the lens can be optimized depending on a focal length to be aimed at, a targeted incident angle and a wavelength of the incident light. It should be noted that, in the equation (1), a light-collecting component is defined by a quadric of a distance x from a center of a unit pixel, and a deflection component is defined by a product of x multiplied by a trigonometric function.

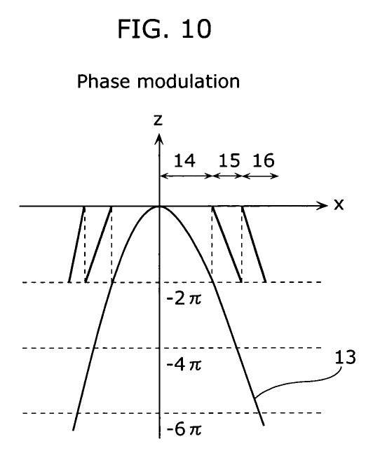

In the present embodiment, a propagation direction of light can be controlled by performing phase modulation on the incident light according to a refractive index distribution. Herein, as shown in FIG. 10, the phase modulation generated by the equation (1) is a discontinuous phase modulation obtained by dividing the equation (1) by 2π, not only shown in the first zone 14 but also as the second zone 15 and the third zone 16. However, a zone is separated for each phase so that an effective phase modulation is equal to a continuous phase modulation 13.

Further, a condition for obtaining a phase difference of 2π at a boundary of each zone in the case of forming a light-transmitting film having multiple zones is descried as follows, where L is a lens thickness:
ΔnₘₐₓL=λ (2)
When the light-transmitting film is thin, there is no loss factor in general. Therefore, the light-collection efficiency becomes a hundred percent if the equation (2) is satisfied.

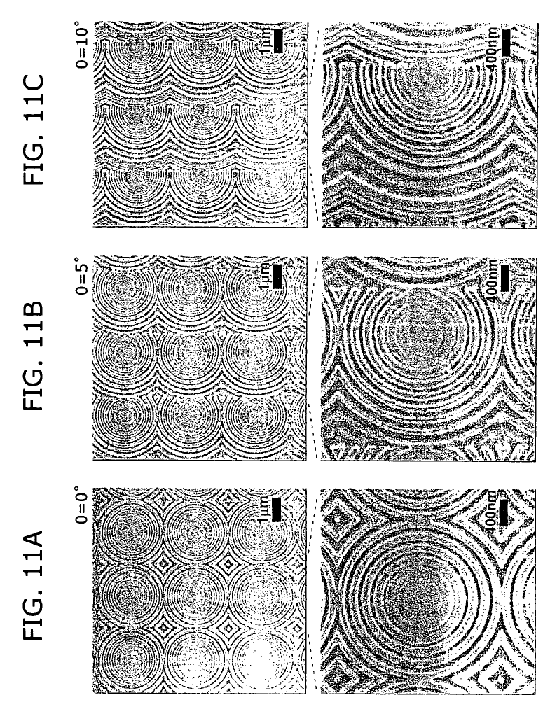

FIGS. 11A to 11C are photographs of gradient index lenses having a concentric circle structure taken by a scanning electron microscope (SEM), according to the present embodiment.

The gradient index lens is a gradient index lens using a difference of refractive indexes between resist (ZEP 520: refractive index 1.56) for electron beam (EB) rendeding and air, that is formed on a fused silica substrate by EB rendering. The details about the manufacturing method are described later. A diameter of the lens is 2.8 μm, a thickness of the lens is 1 μm, and a periodic width of a divided area is 0.2 μm. The gradient index lens is designed by defining that the focal length is 5 μm, the wavelength of incident light is 0.55 μm, a refractive index of the light-incoming side medium is 1.45 (fused silica), and a refractive index of the light-outgoing side medium is 1 (air).

FIG. 11A is a SEM photograph of a top surface of the gradient index lens whose incident angle setting value is 0° (θ=0°). It can be seen that multiple round concentric circles (FIG. 11A) are arranged. As the incident angle setting value is increased by 5° (FIG. 11B) and by 10° (FIG. 11C), the concentric circles shift to a right direction on the paper. This indicates that the regions with high effective refractive indexes shift to the right side.

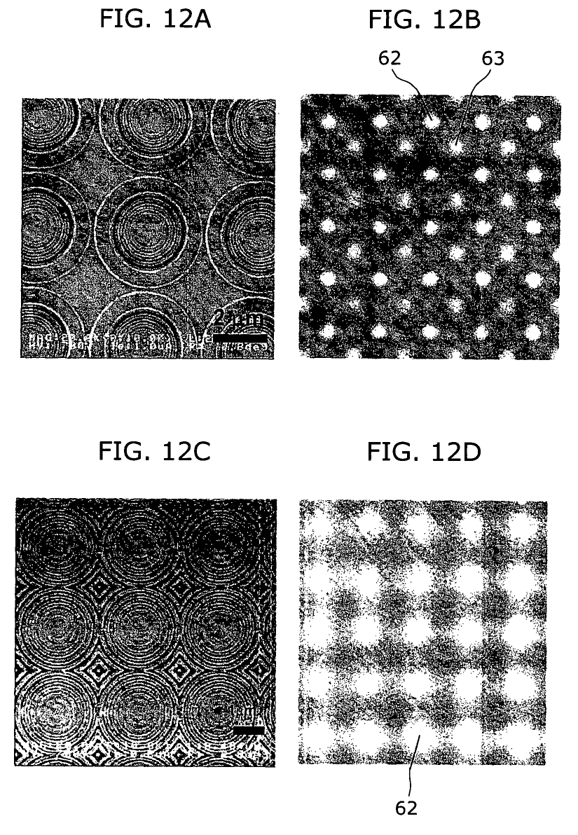

FIGS. 12A to 12D show a comparison between a round incident window region and a square incident window region.

In the case where the incident window region is round (FIG. 12A), a space is generated between the lenses as shown in FIG. 12B. Therefore, leakage light 163 is generated other than a light-collecting spot 162, which results in a large light-collecting loss. However, when the incident window region is square and the present refractive index distribution is formed also in a region shared with an adjacent lens (FIG. 12C), the incident light in a whole pixel area can be collected as shown in FIG. 12D. Therefore, the leakage light 163 is prevented and the light-collecting loss can be reduced.

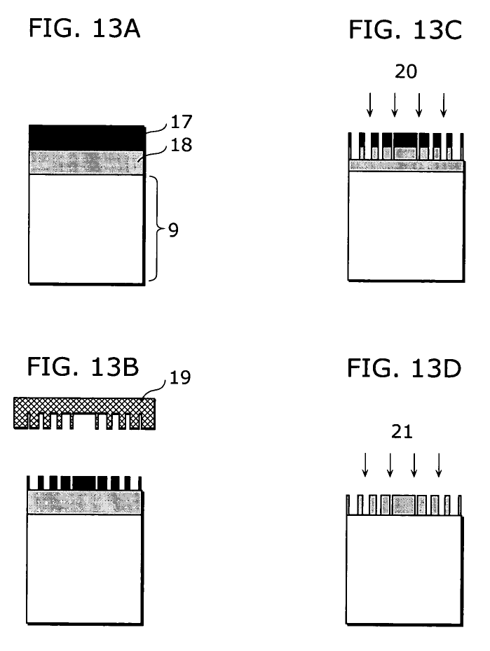

FIGS. 13A to 13D are diagrams showing a process of manufacturing the gradient index lens according to the present embodiment. The gradient index lens is formed by nanoimprinting and etching.

First, using a general semiconductor process, an LCD panel 9 (not shown in FIG. 13) is formed including transparent electrodes, a liquid crystal layer, a color filter, and a black matrix filter that are formed on a glass substrate. The size of one unit pixel is 20 μm square.

Then, using plasma CVD, a TiO₂ film 18 is formed and resist 17 is coated on the TiO₂ film 18 (FIG. 13A). The thicknesses of the TiO₂ film 18 and the resist 17 are both 0.5 μm. A mold 19 made of SiC which is patterned to the concentric circle structure is hot-pressed on the resist 17 at 150° C., and a fine structure is transferred to the resist 17 as the result (FIG. 13B). The mold 19 is formed by a general electron beam lithography and etching.

After post-baking the above processed structure at 180° C., the first etching 20 is performed by Ar ion milling (FIG. 13C). After the resist 17 is removed, the concentric circle structure is formed on a pixel by wet etching 21 (FIG. 13D).

It should be noted that, while, in the present embodiment, the gradient index lens is placed on a top surface of a unit pixel, it may be formed in a layer (e.g. form the gradient index lens between a color filter and a black matrix filter). Consequently, a flexibility of designing a structure of the unit pixel is expanded and the manufacturing process can be simplified.

### Second Embodiment

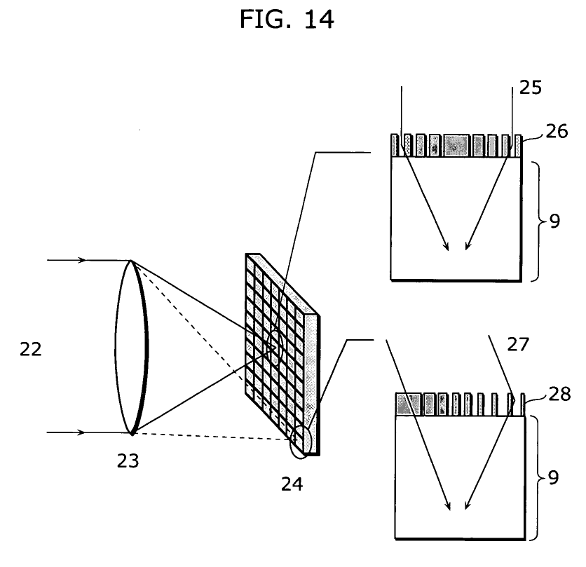

FIG. 14 is a diagram showing unit pixels arranged two dimensionally on an LCD panel using a video graphic array (VGA) (310,000 pixels) according to the second embodiment. In FIG. 14, incident light 22 is collected by an optical lens 23, and emitted on an LCD panel 24 having gradient index lenses. In a unit pixel 9 made up of a liquid crystal layer and a black matrix filter and in an LCD panel on which the gradient index lenses are arranged two-dimensionally, an incident angle of light at unit pixels in a center portion and that of unit pixels in a peripheral portion are different. While the incident light is incident on the unit pixels at nearly 0° in the center portion, it is incident on the unit pixels at around 30° in the peripheral portion.

The gradient index lens in each unit pixel according to the present embodiment is a gradient index lens which corresponds to a component of the incident light with the strongest light intensity that is incident on each unit pixel from a center portion to a peripheral portion of the LCD panel. Each gradient index lens optimizes its lens structure depending on a position of the unit pixel on the LCD panel so as to obtain the highest light-collection efficiency.

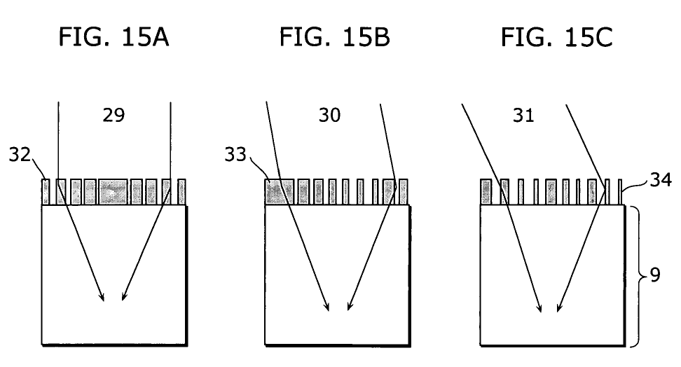

FIGS. 15A to 15C are diagrams, each of which shows a fundamental structure of a unit pixel according to the second embodiment. The incident light 29, 30 and 31 which are incident into an incident window respectively at an incident angle of 0°, α° and 2α° are collected respectively by a gradient index lens 32 for 0° incident light, a gradient index lens 32 for α° incident light, and a gradient index lens 33 for 2α° incident light, and pass sequentially through a black matrix filter, a liquid crystal layer and further an LCD panel.

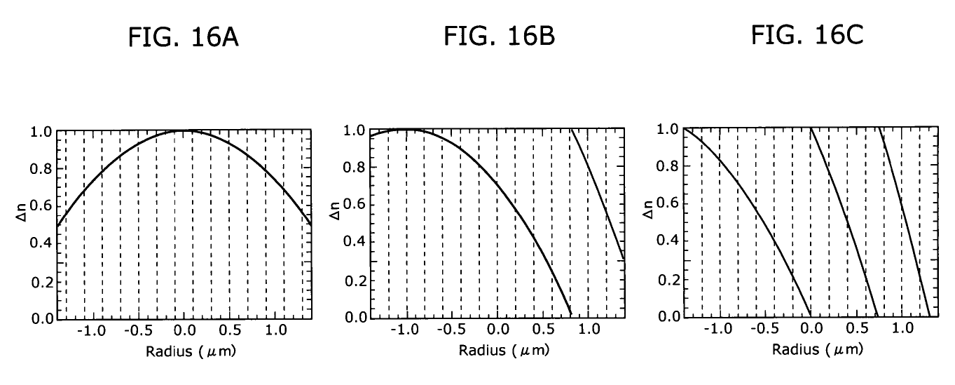

As the incident angle of illumination-light increases, the maximum value of the refractive index distribution of the first zone shifts to the light-incoming side (FIGS. 16A to 16C). If the angle is further increased, the second and third zones are appeared. Even for the incident light which is incident at an angle that is equal to or higher than 45°, the high light-collection efficiency can be maintained by using multiple zones. In principle, in the case where a film thickness is for one phase, the light-collection efficiency becomes a hundred percent. However, in the case where the film thickness does not satisfy the equation (2) or a periodic structure of each zone arrangement is not formed for each phase, the light-collection efficiency is reduced.

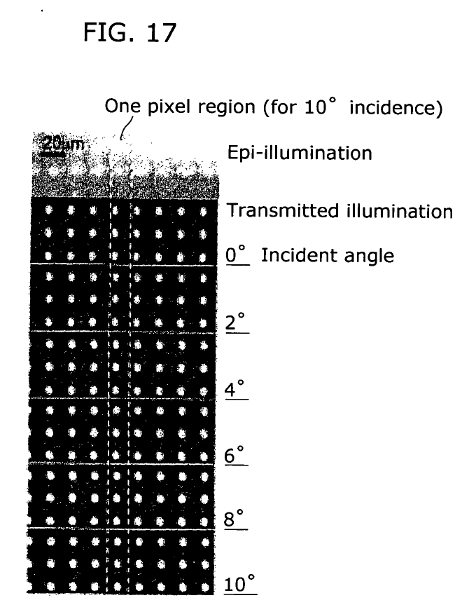

FIG. 17 is a diagram showing an example of dependency of light-collecting spot positions on the incident angle. FIG. 17 is a light-optic microscope photograph (one pixel region indicated with two dashed lines), and shows a characteristic of the gradient index lens optimized for the incident angle 10°. In the case where the incident light is incident vertical (0°) to the lens, the light-collecting spots appear at an edge of a unit pixel (a region surrounded by dotted lines). As the incident angle increases, the light-collecting spots shift to the right side on the paper. In the case of the incident angle 10°, spots are observed nearly in a center of the unit pixel. It indicates that the incident light which incidents diagonally to the LCD panel has been able to be collected efficiently at the center of the unit pixel.

FIG. 18 is a diagram showing a dependency of the light-collection efficiency on pixel positions. In FIG. 18, an increase of the incident angle indicates that a position of a unit pixel is in a peripheral portion of the LCD panel. In FIG. 18, data of a solid-state imaging device having a microlens is described in parallel for a purpose of comparison. As is clear from FIG. 18, in a high angle region of the incident angle which is equal to or higher than 20°, it has been succeeded to obtain better light-collection efficiency than the solid-state imaging apparatus using a microlens. This result indicates that a high-luminance LCD panel whose light-collection efficiency does not depend on a pixel position can be manufactured.

Further, in the gradient index lens according to the present embodiment, a structure of a gradient index lens of each unit pixel can be optimized depending on a wavelength of the incident light so that there is no difference in light-collection efficiency among colors. Therefore, it can collect light highly efficiently.

In addition, in the gradient index lens according to the present invention, the lens structure of each unit pixel can be optimized depending on a focal length of the incident light. Therefore, it can obtain high light-collection efficiency by designing a lens corresponding to a pixel structure. In the present embodiment, around 80 percent of the incident light is lead to the liquid crystal layer by setting a focal point at an aperture of the black matrix filter.

It should be noted that the gradient index lens according to the first and second embodiments is manufactured by the nanoimprinting method, and is a gradient index lens using a difference of refractive indexes between TiO₂ and air.

### Third Embodiment

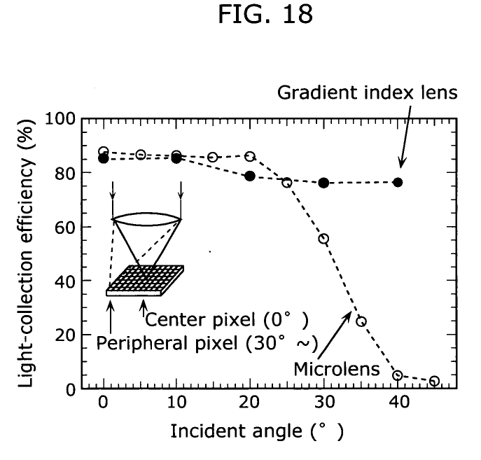

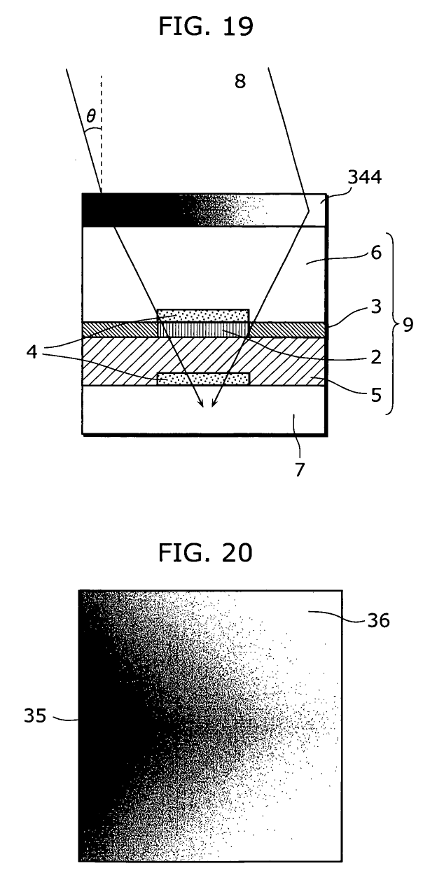

FIG. 19 is a diagram showing a fundamental structure of an LCD panel compatible to SVGA (480,000 pixels) according to the third embodiment. Each unit pixel is made up of a gradient index lens 344, a color filter 2, a black matrix filter 3, transparent electrodes 4, a liquid crystal layer 5, a counter substrate 6, and a glass substrate 7.

FIG. 20 is an example of a top view of the gradient index lens according to the present embodiment. The refractive index of this gradient index lens continuously changes, in an in-plane direction, from a high refractive index region 35 (e.g. GeO₂ (n=1.65)) to a low refractive index region 36 (SiO₂ (n=1.45)). Since the refractive index is continuously distributed, the loss of scattering light on a surface of the lens is prevented and the light-collection efficiency is largely improved. The refractive index distribution according to the present embodiment is a single zone. Also, a thickness of the gradient index lens 344 is 1 μm.

Further, in an optical device according to the present embodiment, it is set to have a constant value of the light-collection efficiency in an aperture by controlling the refractive index distribution of the light-transmitting film. Accordingly, the luminance of each unit pixel becomes constant so that unevenness of the luminance on the LCD panel is prevented.

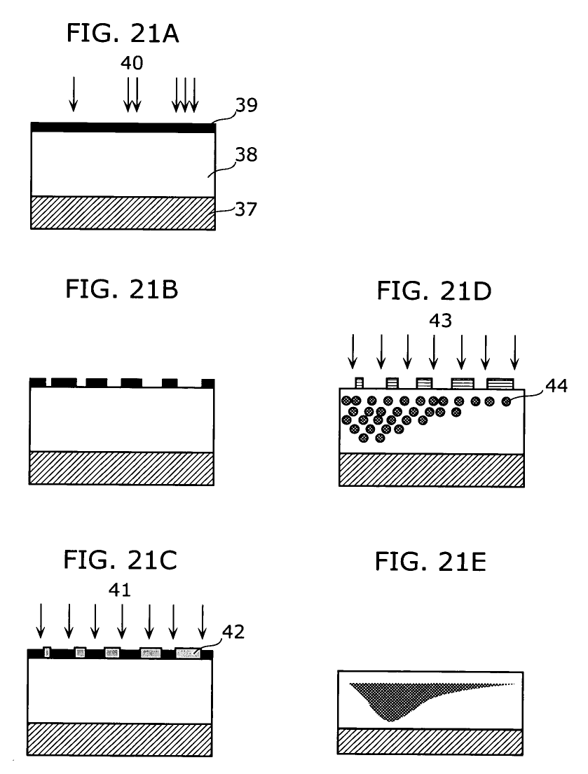

FIGS. 21A to 21E are diagrams showing a manufacturing process of the gradient index lens according to the present embodiment. The lens formation is performed by implanting ions. First, using a general semiconductor process, a liquid crystal panel 37 is formed including transparent electrodes, a liquid crystal layer, a color filter and a black matrix filter that are formed on the glass substrate. Then, a SiO₂ film 38 is formed using a spattering apparatus and resist 39 is coated on the above. After that, it is patterned with electron beam exposure 40 (FIG. 21A). The thicknesses of the SiO₂ film 38 and the resist 39 are both 0.5 μm. After the development (FIG. 21B), electron beam evaporation 41 of a metal (Au is used for this case) as a mask is performed (FIG. 21C). After removing the resist 39, an ion implantation 43 of Ge 44 is performed under accelerating voltage of 180 keV (FIG. 21D). After the resist 39 is removed, the above processed structure is post-baked at 600° C. and a gradient index lens whose refractive index is distributed continuously on the pixel can be manufactured (FIG. 21E).

### Fourth Embodiment

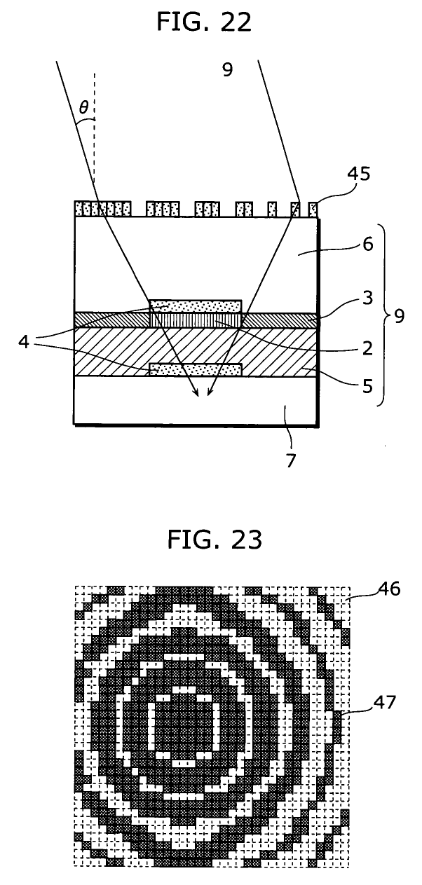

FIG. 22 is a diagram showing a fundamental structure of an LCD panel compatible to a VGA (310,000 pixels) according to the fourth embodiment. Each unit pixel is made up of a gradient index lens 45, a color filter 2, a black matrix filter 3, transparent electrodes 4, a liquid crystal layer 5, a counter substrate 6 and a glass substrate 7.

FIG. 23 is an example of a top view of the gradient index lens according to the present embodiment. This gradient index lens has a structure in which a light-transmitting material has a diameter that is equal to or shorter than a wavelength of light to be incident in an in-plane direction is scattered unevenly in or on light-transmitting films having different refractive indexes. Herein, the effective refractive index of the incident light can be calculated from a volume ratio between a high refractive index material 47 and a low refractive index material 46. The best characteristic feature of this gradient index lens is that a gradient index device can be easily manufactured by changing an effective refractive index by changing a space between adjacent high refractive index materials. In the present embodiment, the high refractive index material 47 (e.g. TiO₂ (n=2.43)) with 0.2 μm or less on a side is scattered in the low refractive index material 46 (e.g. SiO₂ (n=1.45)).

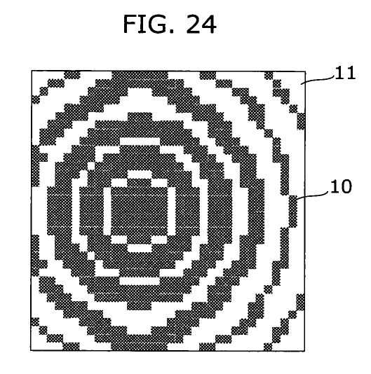

Here, the high refractive index material and the low refractive index material may be connected to each other like a bracelet (FIG. 24). On apparent, it can be seen that the circular structure has a step structure. However, in the case where the step structure is efficiently smaller than the wavelength of the incident wave, high light-collection efficiency can be obtained (the light-collection efficiency is about 80 percent).

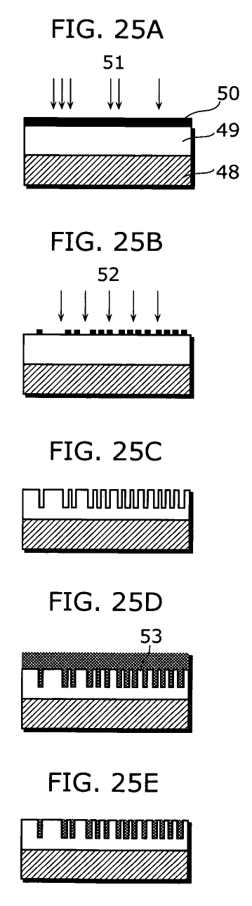

FIGS. 25A to 25D are diagrams showing a process of manufacturing the gradient index lens according to the present embodiment. The lens formation is performed by electron beam rendering and etching. First, using a general semiconductor process, transparent electrodes, and a liquid crystal panel 48 (not shown in FIGS. 25) is formed including a liquid crystal layer, a color filter, and a black matrix filter that are formed on the glass substrate. After that, a SiO₂ film 49 is formed and the resist 50 is coated on the above, using a spattering apparatus. Then, it is patterned with electron beam exposure 51 (FIG. 25A). The thicknesses of the SiO₂ film 49 and the resist 50 are both 0.5 μm. After the development, a fine structure is formed on a surface of the unit pixel by etching 52 (FIG. 25B).

It should be noted that the manufacturing process of the gradient index lens according to the first embodiment is completed when the resist is exposed and developed. After the resist 50 is removed, TiO₂ is accumulated using plasma CVD (FIG. 25C). After removing the TiO₂ layer which has covered whole area of the unit pixel by surface polishing, the processed structure is post-baked at 800° C. (FIG. 25D). Through the above mentioned process, a gradient index lens in which the light refractive index materials are scattered unevenly on a unit pixel is manufactured.

### Fifth Embodiment

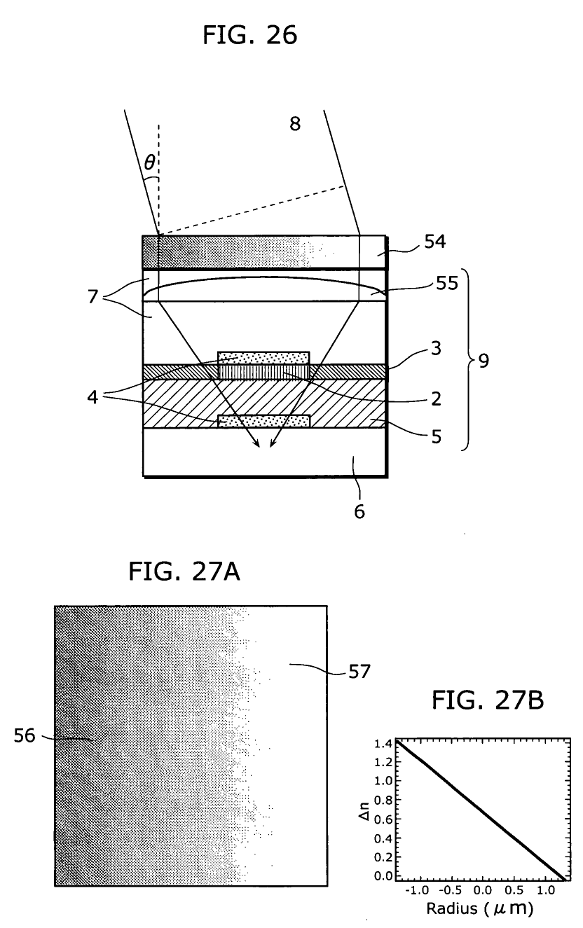

FIG. 26 is a diagram showing an LCD panel including a light-transmitting film having a deflection component according to the present invention and a conventional microlens. Each unit pixel (20m square in size) is made up of a gradient index lens 54, a microlens 55, a color filter 2, a black matrix filter 3, transparent electrodes 4, a liquid crystal layer 5, a counter substrate 6, and a glass substrate 7.

FIG. 27A shows an example of a top view of the gradient index lens. The refractive index of the gradient index lens 54 changes continuously, in an in-plane direction, from a high refractive index region 56 (e.g. GeO₂ (n=1.65)) to a low refractive index region 57 (e.g. SiO₂ (n=1.45)). The refractive index distribution of the gradient index lens 54 according to the present embodiment is set so as to provide a distribution indicated in the second term within the brackets of a right-hand side of the equation (1). A component of the second term is a linear function of x so that the variation of the refractive index is linear and the refractive index of light on a light-incoming side becomes high. While single zone is used in the present embodiment, multiple zones may be used. While the microlens is placed below the gradient index lens, it may be placed above the gradient index lens. Further, a light-collecting device may be a gradient index lens. What is significant here is to separate the light-collecting component and the reflection component. Consequently, a lens structure becomes simple and the lens is easily manufactured.

### Sixth Embodiment

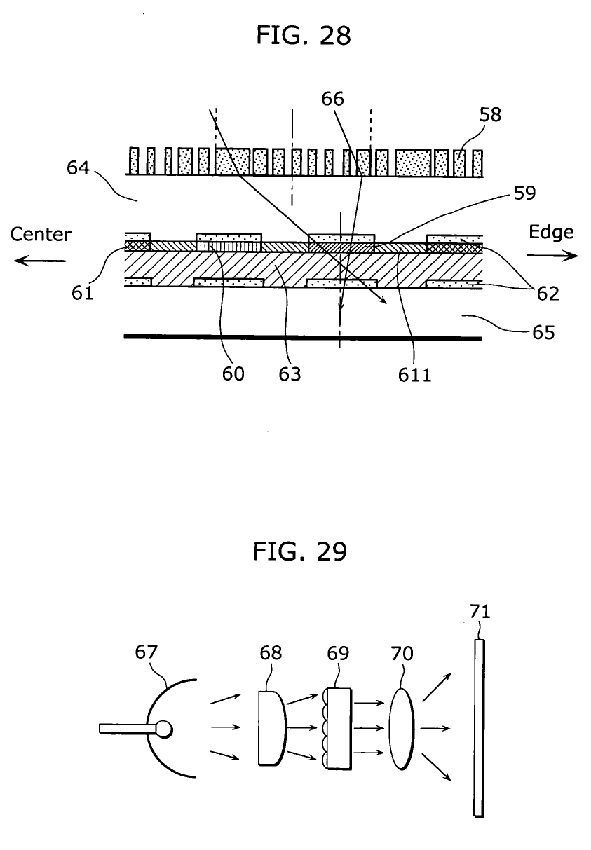

FIG. 28 is a diagram showing an LCD panel in which a position of a central axis of an optical device and a position of a central axis of an aperture (respectively indicated with alternate long and short dash lines) are shifted, according to the sixth embodiment. Each unit pixel (20 μm square in size) is made up of a gradient index lens 58, a color-filter 59 for green (G), a color filter 60 for red (R), a color filter 61 for blue (B), a black matrix filter 611, transparent electrodes 62, a liquid crystal layer 63, a counter substrate 64, and a glass substrate 65.

As described in the above, the LCD panel is made up of multiple unit pixels that are arranged in a two-dimensional array. Therefore, in the case of the incident light with a spread angle, an incident angle at a center pixel is different from an incident angle at a peripheral pixel (refer to FIG. 2). As the result, the light-collection efficiency of the peripheral unit pixel is lowered than that of the central unit pixel.

Accordingly, in the LCD panel of the present embodiment, the black matrix filter layer 611 is down-sized against a panel center. Consequently, while the central axis of the optical device and the central axis of the aperture match each other in the panel center, the central axis are largely misaligned each other in the panel periphery. As the result, the incident light 66 whose incident angle is greater in a periphery of the LCD panel can effectively pass through the aperture, and the unevenness of luminance on the LCD panel is moderated. Further, the structure of the optical device can be simplified so that the formation of the device becomes easier.

### Seventh Embodiment

FIG. 29 is a diagram showing a structure of a single-panel LCD projector using the LCD panel according to the seventh embodiment. An optical system is made up of a light source 67, a light-collecting lens 68, an LCD panel, a projecting lens 70, and a screen 71.

In the LCD panel, color separation filters for red, blue and yellow, and the gradient refractive lens optimized to an angle and wavelength of the incident light are placed. Here, a focal point of the incident light is an aperture of the black matrix filter. Accordingly, most of the incident light can be reached to a liquid crystal layer and the luminance of the projector is increased.

Further, for a present color filter, color separation is performed using a pigment filter or a staining filter. However, it is difficult to make the pigment filter thin and the staining filter has a problem of fading. Accordingly, a thin film color filter with color reproducibility can be formed by using a dielectric multi-layer filter as a color separation device of each unit pixel. Further, the filter can be made of an inorganic material so that, in addition to adhering to the conventional semiconductor process, a filter with small elapsed-time variation can be also formed.

### Eighth Embodiment

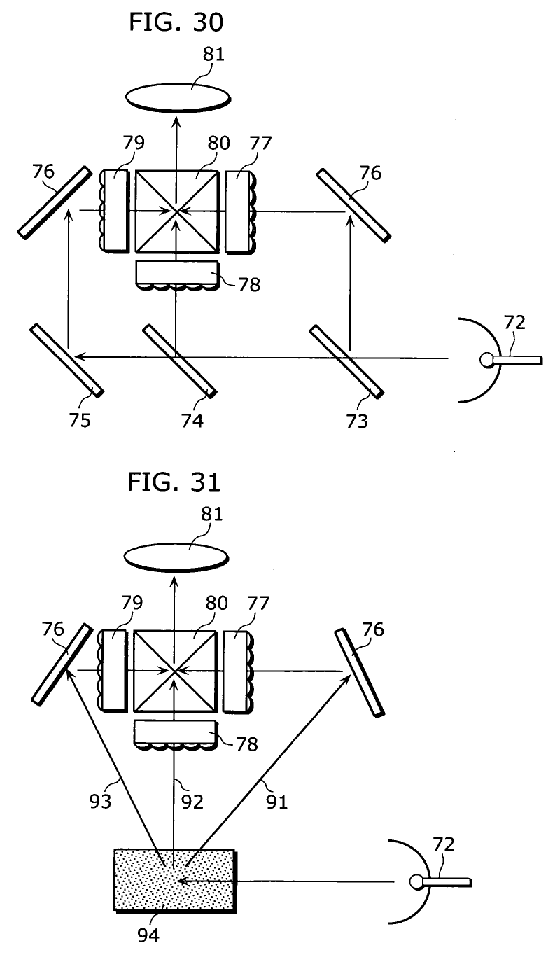

FIG. 30 is a diagram showing a structure of a three-panel LCD projector using the LCD panel according to the eighth embodiment. An optical system is made up of a light source 72, a reflecting mirror 73 for red (R), a reflecting mirror 74 for green (B), a reflecting mirror 75 for blue (B), a total reflecting mirror 76, an LCD panel 77 for R, an LCD panel 78 for G, an LCD panel 79 for B, a prism 80, and a projection lens 81.

The three-panel LCD projector projects light corresponding to three primary colors of red, green and blue respectively to three black-and-white LCD panels 77 to 79 (a panel without color filters in the first to six embodiments), and synthesizes obtained images of each primary color component by the prism 80, and projects the synthesized image to the screen. The gradient index lens on the LCD panel is optimized to an angle and wavelength of the incident light.

Further, while a dichroic mirror is used as the reflecting mirrors 73 to 75, a photonic crystal having a color separation function may be used. The light with an arbitral wavelength can be extracted at a different angle by controlling a scattering plane by changing a periodic circle, refractive index of a material of the photonic crystal (refer to Japanese Patent Publication No. 2003-304937).

### Ninth Embodiment

FIG. 31 is a diagram showing a structure of a three-panel LCD projector using a photonic crystal, according to the ninth embodiment. The optical system is simplified and the miniaturization becomes easier by using a photonic crystal 94 having a color separation function in place of the dichroic crystal. Further, the costs are reduced because the number of constituents of the optical device is reduced.

A thin rear-projection television with high luminance and a large screen can be manufactured by using the LCD panel according to the first to sixth embodiments or the LCD projector according to the seventh to ninth embodiments, as an optical engine of a rear-projection optical system.

It should be noted that an LCD panel including a gradient index lens made of other materials having a same characteristic as the mentioned gradient index lens may be used. Further, the LCD is panel may be manufactured using a manufacturing method other than the explained manufacturing method.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

An LCD panel according to the present invention can be used for realizing a low price and an improvement of capability of an image projecting apparatus such as an LCD projector and a rear-projection television, and is useful for an industrial use.

What is claimed is:

1. A liquid crystal display panel comprising light-transmittable unit pixels that are arranged in a two-dimensional array,
wherein each of said unit pixels includes:
an optical device having a light-transmitting film which collects incident light; and
a liquid crystal layer which allows the light that has passed through said optical device to pass through an aperture of a light-shielding layer, and
wherein in said optical device, a refractive index distribution for incident light from a fixed direction is asymmetrical to a surface-center of said light-transmitting film.

2. The liquid crystal display panel according to claim 1,
wherein in said optical device, the asymmetrical refractive index distribution is also formed in a region adjacent to an optical device of another unit pixel that is adjacent to said current unit pixel.

3. The liquid crystal display panel according to claim 1, comprising at least:
a first unit pixel for a first color light having a first representative wavelength of the incident light; and
a second unit pixel for a second color light having a second representative wavelength of the incident light, the second representative wavelength being different from the first representative wavelength,
wherein said first unit pixel includes a first optical device, and
said second unit pixel includes a second optical device in which a focal length for the second color light is equal to a focal length for the first color light in said first optical device of said first unit pixel.

4. The liquid crystal display panel according to claim 3,
wherein the focal length is set at a predetermined position by controlling the refractive index distribution on said light-transmitting film.

5. The liquid crystal display panel according to claim 1,
wherein the refractive index distribution on the light-transmitting film of said optical device is set so that, for light with the greatest light intensity, a light collection efficiency at the aperture is equal to or greater than a predetermined value.

6. The liquid crystal display panel according to claim 1,
wherein the refractive index distribution on the light-transmitting film of said optical device is defined so that a predetermined value is obtained for a light-collection efficiency at the aperture regardless of a position of a unit pixel in said liquid display crystal panel.

7. The liquid crystal display panel according to claim 1,
wherein in each of said unit pixels, a position of a focal point of the light collected by said optical device matches a position of the aperture.

8. The liquid crystal display panel according to claim 1,
wherein said optical device is formed in an in-layer region above the aperture.

9. The liquid crystal display panel according to claim 1,
wherein each of said unit pixels further includes a light-collecting lens on a light-incoming side or a light-outgoing side of said optical device.

10. The liquid crystal display panel according to claim 9,
wherein said light-collecting lens is one of a gradient index lens and a thickness distribution lens.

11. The liquid crystal display panel according to claim 1,
wherein a refractive index distribution on said light-transmitting film according to an optical device of a unit pixel positioned in a center of said liquid crystal display panel is different from a refractive index distribution on said light-transmitting film lo according to an optical device of a unit pixel positioned in a periphery of said liquid crystal panel.

12. The liquid crystal display panel according to claim 1,
wherein in each of said optical devices,
Δn(x)=Δnₘₐₓ└(Ax²+Bx sin θ)/2π+C┘
is approximately satisfied when a difference from a refractive index of a medium on a light-incoming side which depends on a distance x in an in-plane direction is Δn(x), where A is an incident angle of the incident light, Δnₘₐₓ is a maximum value of the difference from the refractive index of the medium on the light-incoming side, and A, B and C are predetermined constants.

13. The liquid crystal display panel according to claim 12,
wherein in each of said optical devices, further,
ΔnₘₐₓL=λ
is approximately satisfied where L is a thickness of said light-transmitting film and λ is a wavelength of the incident light.

14. The liquid crystal display panel according to claim 1,
wherein said light-transmitting film forms concentric circles that are respective zones obtained by dividing said light-transmitting film by a periodic width in an in-plane direction, the periodic width being equal to or shorter than a wavelength of the incident light, and
each zone has a different ratio of a sum of line widths to the periodic width.

15. The liquid crystal display panel according to claim 14,
wherein a shape of a cross-section of said light-transmitting film in a direction of a normal line is a rectangular.

16. The liquid crystal display panel according to claim 1,
wherein a perimeter of each of the concentric circles is formed to have a step-like shape.

17. The liquid crystal display panel according to claim 1,
wherein in said light-transmitting film, a light-transmitting material is scattered unevenly, the light-transmitting material having a diameter that is equal to or shorter than a wavelength of light to be incident in an in-plane direction.

18. The liquid crystal display panel according to claim 1,
wherein in said light-transmitting film, the refractive index distribution changes continuously.

19. The liquid crystal display panel according to claim 1,
wherein said light-transmitting film is made of a high-refractive index transparent material having a refractive index between 1.45 and 3.4.

20. The liquid crystal display panel according to claim 1,
wherein said light-transmitting film includes one of TiO₂, ZrO₂, Nb₂O₅, Ta₂O₅, Al₂O₃, HfO₂, Si₃N₄ and Si₂N₃.

21. The liquid crystal display panel according to claim 1,
wherein said light-transmitting film includes one of SiO₂ doped with one of B and P, that is Boro-Phospho Silicated Glass, and Teraethoxy Silane.

22. The liquid crystal display panel according to claim 1,
wherein said light-transmitting film includes one of benzocyclobutene, polymethymethacrylate, polyamide and polyimide.

23. The liquid crystal display panel according to claim 1,
wherein each of said unit pixels which is positioned in a center of said liquid display panel is formed so that a central axis of the aperture matches a central axis of said optical device, and each of said unit pixels which is positioned in a periphery of said liquid display panel is formed so that a central axis of said optical device is shifted to the center of said liquid display panel than a central axis of the aperture.

24. A liquid crystal display projector which displays an image on a predetermined screen by applying illumination-light to a liquid crystal panel and projecting the light onto said screen using a projection lens, the light passing through the image displayed on said liquid crystal panel,
wherein said liquid crystal display panel comprises light-transmittable unit pixels that are arranged in a two-dimensional array,
each of said unit pixels includes:
an optical device having a light-transmitting film which collects incident light; and
a liquid crystal layer which allows the light that has passed through said optical device to pass through an aperture of a light-shielding layer, and
wherein in said optical device, a refractive index distribution for incident light from a fixed direction is asymmetrical to a surface-center of said light-transmitting film, and
a color filter is placed near said optical device while irradiating the illumination-light to said liquid crystal display panel.

25. The liquid crystal display projector according to claim 24,
wherein the color filter is a dielectric multi-layer film filter.

26. A liquid crystal display projector which displays an image on a predetermined screen, after allowing a color separation unit to separate illumination-light into colors, by applying the light onto a liquid crystal display panel, synthesizing the light passing through the image displayed on said liquid crystal panel, and projecting the image onto said screen using a projection lens,
wherein said liquid crystal display panel comprises light-transmittable unit pixels that are arranged in a two-dimensional array,
each of said unit pixels includes:
an optical device having a light-transmitting film which collects incident light; and
a liquid crystal layer which allows the light that has passed through said optical device to pass through an aperture of a light-shielding layer, and
wherein in said optical device, a refractive index distribution for incident light from a fixed direction is asymmetrical to a surface-center of said light-transmitting film.

27. The liquid crystal display projector according to claim 26,
wherein said color separation unit is operable to separate the light into colors using a dichroic mirror.

28. The liquid crystal display projector according to claim 26,
wherein said color separation unit is operable to separate the light into colors using a photonic crystal having a color separation function.

29. The liquid crystal display projector according to claim 24,
wherein the colors of the light separated by said color separation unit are red, green and blue.

30. A rear-projection television which enlarges and projects an image projected from a liquid crystal display projector onto a rear side of a screen using a reflection mirror,
wherein the liquid crystal display projector is operable to display an image on a predetermined screen by applying illumination-light to a liquid crystal panel and projecting the light onto said screen using a projection lens, the light passing through the image displayed on said liquid crystal panel,
said liquid crystal display panel comprises light-transmittable unit pixels that are arranged in a two-dimensional array,
each of said unit pixels includes:
an optical device having a light-transmitting film which collects incident light; and
a liquid crystal layer which allows the light that has passed through said optical device to pass through an aperture of a light-shielding layer, and
wherein in said optical device, a refractive index distribution for incident light from a fixed direction is asymmetrical to a surface-center of said light-transmitting film, and
a color filter is placed near said optical device while irradiating the illumination-light to said liquid crystal display panel.

31. A manufacturing method of a liquid crystal display panel in which light-transmittable unit pixels are arranged in a two-dimensional array, said method comprising
forming a light-transmitting film by one of ion implantation, ion exchange, an electron beam rendering, a light-beam rendering, and nanoimprinting using a mold with a minimum processing measure of 1 nm or less,
wherein in the light-transmitting film placed on each of the unit pixels of the liquid crystal display panel, a refractive index distribution for incident light from a fixed direction is asymmetrical to a face-center of the light-transmitting film, the light-transmitting film being formed by a semiconductor process.

32. The liquid crystal display projector according to claim 26,
wherein the colors of the light separated by said color separation unit are red, green and blue.
